(19) United States
(12) Patent Application Publication
(10) Pub. No.: US 2005/0108575 A1
(43) Pub. Date: May 19, 2005

(54) Apparatus, system, and method for faciliating authenticated communication between authentication realms

(76) Inventor: Chong Ming Yung, Lyneham (AU)

Correspondence Address: KUNZLER & ASSOCIATES, 8 EAST BROADWAY, SALT LAKE CITY, UT, 84111, US

(21) Appl. No.: 10/987,475

(22) Filed: Nov. 12, 2004

Related U.S. Application Data
(60) Provisional application No. 60/520,675, filed on Nov. 18, 2003.

(51) Int. Cl. H04L 9/00; H04L 9/32

(52) U.S. Cl. 713/201

(57) ABSTRACT

An apparatus, system, and method are disclosed for facilitating authenticated communication between authentication realms. The present invention includes an authentication gateway configured to authenticate a principal using a first authentication protocol. The first authentication protocol may be one of a variety of authentication protocols. A generator in communication with the authentication gateway generates a foreign realm authentication token that is compatible with a second authentication protocol and configured for inter-realm communication. A foreign realm authentication module then authenticates the principal to access services of a foreign realm using the foreign realm authentication token. The authentication is performed by the foreign realm authentication module in accordance with the second authentication protocol. The first authentication protocol may be a non-Kerberos protocol and the second authentication protocol may be a Kerberos protocol.

### CROSS-REFERENCES TO RELATED APPLICATIONS

This application claims the benefit of U.S. Provisional Patent Application No. 60/520,675 entitled “User Authentication” and filed on Nov. 18, 2003 for Chong Ming Yung.

### BACKGROUND OF THE INVENTION

1. Field of the Invention

This invention relates to network authentication protocols and more particularly relates to an apparatus, system, and method for facilitating authenticated communications between authentication realms.

2. Description of the Related Art

Use of software programs and services provided by computers over networks continues to increase rapidly. Access to the services and software of computer systems in various entities is often tightly controlled and limited to only authorized users. The users may be real people or other software programs that are permitted to access the services.

Increasingly, different computer systems and services are being combined into a single interface such as a portal or website to simplify use by the users. The lines between computers and services offered by one enterprise and another enterprise are blurring. As used herein, the term “services” refers to any functionality one computer system can perform for the benefit of another computer system. Services may include web services, remote procedure calls, dynamic web page generation, database search services, and the like.

It is desirable to permit a user to seamlessly transition from services of one enterprise to another. This feature is often referred to as federated identity management and includes the ability to transition from one authentication protocol to a different type of authentication protocol. Federated identity management allows a user to use the same user name and password or other identifying information to sign on to a plurality of networks that employ different authentication systems. Conventionally, users have to login to each enterprise to authenticate themselves, unless the two enterprises use a common authentication system. Consequently, the user must typically manage different passwords and/or user names for each enterprise.

Generally, the security infrastructure in modem enterprises includes multiple heterogeneous authentication systems, one of which increasingly tends to be Kerberos. Kerberos is a security system based on the concept of a trusted third party that brokers trust between communicating entities, and is used to provide authentication, integrity, and privacy to communications in untrusted networks. An authentication system such as Kerberos typically permits two different enterprises to authenticate each other for inter-enterprise communication. However, the authentication systems typically require that both enterprises use the same authentication protocol, such as Kerberos. One security system may be divided into a plurality of smaller security systems known as realms, security zones, security domains, administrative domains, or simply domains. The realms may be defined based on geography, enterprise boundaries, common purposes, or other common attributes among computer systems in the realm.

Kerberos is a well known authentication protocol defined in RFC 1510 [Krb5]. Generally, Kerberos capable systems include a trusted third party known as a Key Distribution Center (KDC) which may authenticate each of the communicating entities before providing each entity with a session key that can be used to encrypt and decrypt subsequent communications between the two entities. The session key is used as a symmetric encryption key, such that if an entity is able to decrypt a received message using the session key, then the message must have been encrypted by the other entity also having the session key. Encrypting each message transferred between the entities, allows the source of each message to be authenticated.

Typically, each realm includes one KDC. The KDC must be able to authenticate the identity of each of the entities. This is typically achieved by assigning each entity with a respective encryption key which is known only to the entity and the KDC, usually during a registration process. In general a KDC is only able to authenticate users within its realm. A single KDC generally cannot authorize communication for entities in different realms.

Typically, a client requesting services from a server in the realm controlled by the KDC communicates with an Authentication Service (AS) in the KDC. The AS authenticates the client and sends the client a Ticket-Granting-Ticket (TGT). References herein to “ticket” and “token” are used interchangeably for consistency and clarity with respect to the terminology used in the art.

The client can send the TGT to a Ticket Granting Service (TGS). The TGS verifies the TGT and, if valid, issues a ticket that contains the session key described above. The client then sends the ticket to the server in the realm managed by the KDC. The server authenticates the ticket and, if valid, permits the client access to the desired service.

As mentioned above, authentication protocols such as Kerberos can accommodate authentication between realms so long as the two realms implement the same authentication protocol and share a secret key. In Kerberos, this is achieved through registering each KDC in one realm as a service available in the other realm and the issuance of cross-realm Ticket Granting Tickets (cr-TGT). Kerberos cross-realm trust can be one-way where one realm trusts the other but not vice versa, or two-way where trust is mutual.

Unfortunately, current authentication protocols such as Kerberos do not permit cross-realm communications between realms employing a different authentication protocol. Many companies, organizations, and the like already implement existing alternative authentication systems, and it can be difficult to bridge these systems with standard authentication protocols such as Kerberos. Heterogeneous authentication or identity systems are in use on the Internet and the industry is facing increased pressure from movements such as Project Liberty to implement Federated Identity Management to allow bridging between disparate authentication systems.

Solutions have been proposed that change a Kerberos authentication system in order to support Federated Identity Management between heterogeneous authentication systems. However, changing such a well known standard can be time consuming, expensive, and it can be difficult to convince users to change. FIG. 1 illustrates one of these solutions with two heterogeneous authentication systems for two enterprises, Realm A and Realm B. Realm A is a non-Kerberos authentication system that includes a client and a non-Kerberos authentication module. Realm B is a modified Kerberos authentication system that includes Server A, Server B, and a KDC that is modified to support non-Kerberos Clients. Specifically, the KDC includes an extension that is added support non-Kerberos Clients. The extension may be implemented in hardware and/or software.

In FIG. 1, the Client and non-Kerberos Authentication module cooperate to authenticate a user using a first authentication protocol 101. The first authentication protocol 101 may include any one of a Public Key Infrastructure (PKI), Passport, Secure Sockets Layer (SSL), Windows NT LAN Manager (NTLM), Digest, or the like. Once authenticated, the Client sends a service request token 102 to Server A.

Here, the solution illustrated in FIG. 1 departs from the standard Kerberos protocol. Rather than the Client communicating directly with the KDC, the Client enlists Server A to operate in the Kerberos realm B on the Client's behalf. This process is known in the art as identity delegation. The Client delegates Server A to vouch for the Client's identity. This is problematic because Server A must be specifically modified to support identity delegation. Furthermore, the Kerberos realm B must trust that Server A is properly verifying the Client's identity. The KDC and users of the Kerberos realm B must implicitly trust that Server A will not act on behalf of any rogue clients.

The service request token 102 may include user identity and/or authentication information such as an assertion about the user's security information in a format consistent with a Security Assertions Markup Language (SAML). Optionally, Server A may accept the service request token 102 or further communicate with the Client to authenticate the Client. The service request token 102 indicates that the Client would like to access services of Server B which only interacts with users according to the Kerberos protocol. In other words, clients of Server B must have a Kerberos ticket.

Server A uses a proprietary extension to the Kerberos protocol in order to obtain a session ticket from the KDC for Server A to be used by the Client. This extension to the Kerberos protocol is known as S4U2Self (Service for the User to Self). The extension protocol requires that Server A and the KDC be modified to include Extension code to support this protocol. According to the proprietary S4U2Self protocol, Server A sends a session ticket request 103 to the KDC.

The session ticket request 103 may include authenticating evidence such as authentication information the Client may have provided in the service request token 102. The KDC is configured to recognize that Server A desires a session ticket to be used by the client in communicating with Server A. If authenticating evidence is provided, extension code in the KDC may validate the authenticating evidence. Consequently, the KDC may have to be modified periodically to support different kinds of authenticating evidence. In addition, the KDC may have to store and preserve authenticating evidence for a variety of Clients in foreign realms such as Realm A. If satisfied, the KDC sends 104 a session ticket for the Client to interact with Server A.

Server A subsequently follows a second proprietary protocol known as S4U2proxy (Service for User to proxy) to obtain a session ticket for the Client to access services on Server B. As discussed above, Server A and the KDC must be modified to support this S4U2proxy protocol. Under this protocol, Server A sends a request token 105 that includes the TGT of Server A and the session ticket for the Client just obtained using the S4U2Self protocol. The KDC authenticates the TGT of Server A and uses the session ticket for the Client obtained using the S4U2Self protocol to produce a session ticket for the requested services of Server B. The session ticket is then sent 106 to Server A. This session ticket is made to appear as though the Client requested it directly from the KDC. Typically, the Client then uses the session ticket for the requested services of Server B to obtain authenticated access to the services of Server B.

As discussed above, the proposed solution requires use of proprietary protocols that require changes to existing software that implement current Kerberos KDCs and certain servers of Kerberos realms. Such code changes may be very time consuming and costly to enterprises that desire to implement authentication between heterogeneous authentication systems.

From the foregoing discussion, it should be apparent that a need exists for an apparatus, system, and method for facilitating authenticated communications between authentication realms. Beneficially, such an apparatus, system, and method would not require any changes to existing authentication systems such as Kerberos. In addition, such an apparatus, system, and method would allow clients to communicate directly with an authentication authority such as a KDC such that activity of clients can be properly tracked and recorded. Such an apparatus, system, and method would support various non-Kerberos authentication systems without requiring any modifications to existing Kerberos authentication systems.

### SUMMARY OF THE INVENTION

The present invention has been developed in response to the present state of the art, and in particular, in response to the problems and needs in the art that have not yet been fully solved by currently available apparatuses, systems, and methods for authenticated communication between authentication realms. Accordingly, the present invention has been developed to provide an apparatus, system, and method for facilitating authenticated communication between authentication realms that overcome many or all of the above-discussed shortcomings in the art.

The apparatus to facilitate authenticated communication between authentication realms is provided with a logic unit containing a plurality of modules configured to functionally execute the necessary steps of authenticating a principal using a first authentication protocol, generating a foreign realm authentication token compatible with a second authentication protocol, the foreign realm authentication token configured for inter-realm communication, and authenticating the principal to access services of a foreign realm using the foreign realm authentication token in accordance with the second authentication protocol. These modules in the described embodiments include an authentication gateway, a generator, and a foreign realm authentication module.

The apparatus, in one embodiment, is configured to generate foreign realm authentication tokens compatible with a token definition of the second authentication protocol for foreign realm authentication tokens. Alternatively, in response to a second authentication protocol that does not support inter-realm authentication tokens, the generator may generate an authentication token compatible within the foreign realm. In other words, the authentication token may be semantically equivalent to authentication tokens issued by native authentication modules such as a foreign realm authentication module associated with the second authentication protocol. In another embodiment, the apparatus may provide pre-generated foreign realm authentication tokens.

In a further embodiment, the apparatus may be configured such that the first authentication protocol is different from the second authentication protocol. The apparatus may further comprise a registration module configured to register the authentication gateway with the foreign realm authentication module such that the authentication gateway has authority to issue foreign realm authentication tokens to principals that satisfy the authentication requirements of the authentication gateway.

The apparatus for facilitating authenticated communication between authentication realms may include a gateway communication module and a validation module. The gateway communication module may be configured to receive an authentication token from the principal. The authentication token may be incompatible with the second authentication protocol. The validation module maybe configured to validate the authentication token according to the first authentication protocol. The authentication token preferably identifies a requested service within the foreign realm and includes credentials for the principal, such as a user name and password. The authentication token may comprise a Security Assertions Markup Language (SAML) token generated by an authentication authority.

The authentication gateway shares a secret key with the foreign realm authentication module. The authentication gateway uses the secret key to encrypt a message within the foreign realm authentication token. The foreign realm authentication module issues an inter-realm token in response to successful decryption of the message using the secret key. The inter-realm token permits authenticated access by the principal to a service of the foreign realm.

The apparatus may also include a packager, a logger, and a principal communication module. The packager may embed an authentication token from the principal in the foreign realm authentication token, the authentication token identifying the principal. The logger logs access to the foreign realm by the principal by way of the foreign realm authentication module. The principal communication module may send the foreign realm authentication token to the foreign realm authentication module, receive a session token valid for services of service providers in the foreign realm according to the second authentication protocol, send the session token to a service provider, and establish service related communications with the service provider in response to the service provider validating the session token.

In certain embodiments, a proxy sends a non-Kerberos authentication token from a user application. The proxy may also receive the cross-realm authentication token. The proxy exchanges communications between the user application and a service in a Kerberos realm in response to successful inter-realm authentication.

A system of the present invention is also presented to facilitate authenticated communication between authentication realms. The system may be embodied as hardware, software, or a combination of these. In particular, the system, in one embodiment, includes a client computer within an authentication realm, a Kerberos gateway server, a Kerberos authentication server, a Kerberos service provider, and a network configured to operatively couple the client computer, Kerberos gateway server, Kerberos authentication server, and Kerberos service provider for networked communications.

In one embodiment, the client computer is configured to solicit credentials from a user of an application and generate a non-Kerberos authentication token. The Kerberos gateway server is registered as a gateway between the authentication realm and a foreign authentication realm and further configured to receive and authenticate the non-Kerberos authentication token. The Kerberos gateway server issues a Ticket-Granting-Ticket (TGT) to the client computer in response to authentication of the user using a non-Kerberos authentication protocol. The Kerberos authentication server is configured to issue a cross-realm ticket and to send the cross-realm ticket to the client computer in response to the TGT from the client computer. The Kerberos service provider establishes a cross-realm communication session with the user application on the client computer in response to the cross-realm ticket from the client computer.

A method of the present invention is also presented for facilitating authenticated communication between authentication realms. The method in the disclosed embodiments substantially includes the steps necessary to carry out the functions presented above with respect to the operation of the described apparatus and system.

Reference throughout this specification to features, advantages, or similar language does not imply that all of the features and advantages that may be realized with the present invention should be or are in any single embodiment of the invention. Rather, language referring to the features and advantages means that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating a conventional inter-realm communication solution that requires changes to an existing authentication protocol;

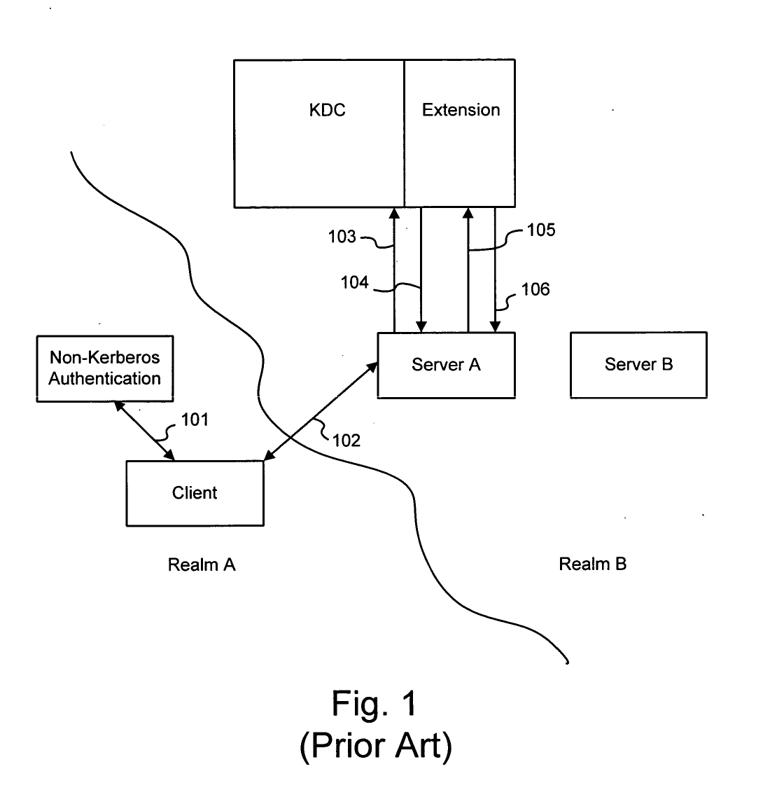

FIG. 2 is a schematic block diagram illustrating one embodiment of an apparatus for facilitating authenticated communication between authentication realms;

FIG. 3 is a schematic block diagram illustrating one embodiment of an alternative apparatus for facilitating authenticated communication between authentication realms;

FIG. 4 is a schematic block diagram illustrating details of one embodiment of an apparatus for facilitating authenticated communication between authentication realms;

FIG. 5 is a schematic block diagram illustrating a system for facilitating authenticated communication between authentication realms; and

FIG. 6 is a schematic flow chart diagram illustrating one embodiment of a method for facilitating authenticated communication between authentication realms in accordance with the present invention.

### DETAILED DESCRIPTION OF THE INVENTION

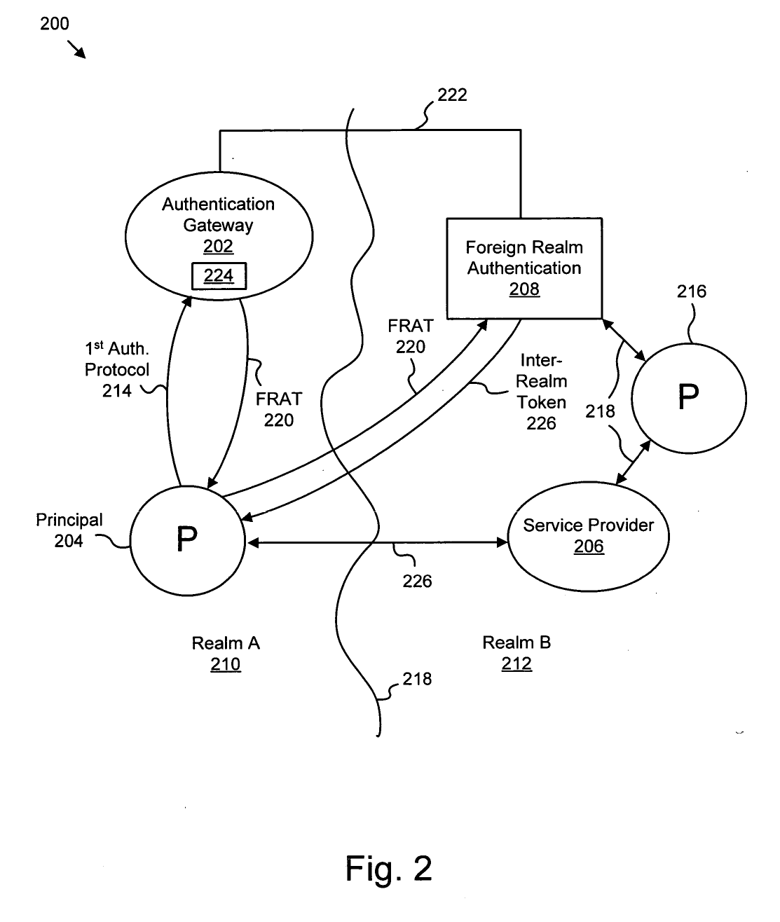

FIG. 2 illustrates an apparatus 200 for facilitating authenticated communication between authentication realms. The apparatus 200 includes an authentication gateway 202, a principal 204, a service provider 206, and a foreign realm authentication module 208. Preferably, the authentication gateway 202 and the principal 204 are in communication with the service provider 206 and foreign realm authentication module 208 via network communications such as a Transmission Control Protocol/Internet Protocol (TCP/IP) network. For security and authentication purposes, the network is organized in to two authentication realms, Realm A 210 and Realm B 212. As mentioned above, realm definitions may be based on various criteria including geography, enterprise boundaries, purposes of members of each realm, and the like.

Because members of Realm A 210 and Realm B 212 are interconnected, services provided to members of a realm (referred to as principals 204) are restricted to those principals 204 that provide proper authentication. Principal 204 refers to the software, both autonomous and user-controlled, operating on a computing device in network communications with the authentication gateway 202, foreign realm authentication module 208, and service provider 206. Principals 204 having proper authentication are also authorized to access the requested services. The authentication gateway 202 and principal 204 are in Realm A 210 which uses a first authentication protocol 214. Representative examples of the first authentication protocol 214 include PKI, Passport, SSL, NTLM, Digest, or the like.

In preferred embodiments, principals 216 of Realm B 212 are authenticated by the service provider(s) 206 using a second authentication protocol 218. For example, suppose that Realm B 212 is authenticated using the Kerberos protocol. For clarity, the apparatus 200 will be described from the perspective of Realm A 210. Consequently, native members of Realm B 212 are foreign to members of Realm A 210. As used herein, the term “foreign” refers to communications originating at a source that cross a realm boundary 218 to reach a destination within a foreign realm.

The service provider 206 provides certain services to the principals 216 after proper authentication. Accordingly, a principal 216 authenticates using the foreign realm authentication module 208 in accordance with the second authentication protocol 218. Of course to the principal 216, the foreign realm authentication module 208 is not foreign and may comprise a standard KDC in embodiments in which the second authentication protocol 218 is Kerberos. The foreign realm authentication module 208 is suitably configured to authenticate the principal 216 as defined by an unaltered or extended form of the second authentication protocol 218.

Preferably, the second authentication protocol 218 includes a predefined set of rules and definitions that permit inter-realm communication between two homogeneous realms. For example, if Realm A and Realm B both use the Kerberos authentication protocol, Realm A would include a KDC as would Realm B. The Kerberos authentication protocol includes a predefined set of rules that permit a principal in one Kerberos realm to access services from service providers in another Kerberos realm. Unfortunately, conventional authentication protocols such as Kerberos do not include rules for permitting inter-realm communication between two homogeneous realms. The apparatus 200 of FIG. 2 overcomes this limitation.

In FIG. 2, suppose Realm A 210 is a non-Kerberos realm and Realm B 212 is a Kerberos realm. Referring now to the principal 204 in Realm A 210, Realm B 212 is a foreign realm that includes a service provider 206. The service provider 206 provides a service desired by principal 204. The principal 204 is configured to authenticate using the first authentication protocol 214 with the authentication gateway 202.

The authentication gateway 202 comprises a translator of authentication tokens between heterogeneous authentication realms. Preferably, the authentication gateway 202 is configured to translate tokens between a first authentication protocol 214 and a second authentication protocol 218. Alternatively, the authentication gateway 202 may be configured to translate between a plurality of source realm authentication protocols and a plurality of destination realm authentication protocols.

Preferably, the authentication gateway 202 is registered with the foreign realm authentication module 208 to issue valid Foreign Realm Authentication Tokens (FRAT) 220. A FRAT 220 is a token or ticket compatible with the second authentication protocol 218. In certain embodiments, the FRAT 220 corresponds to a token definition of the second authentication protocol 218 specifically for inter-realm communication. Specifically, the FRAT corresponds to token definitions for inter-realm communication between homogeneous realms. Consequently, by issuing FRATs 220, the authentication gateway 202 serves as a bridge between two heterogeneous realms without changing any definitions, rules, requirements, or components of the second authentication protocol 218.

Registration of the authentication gateway 202 may comprise exchanging a secret key 222 with the foreign realm authentication module 208. The secret key 222 maybe exchanged electronically or via more conventional mechanisms. For example, operators of the authentication gateway 202 and foreign realm authentication module 208 may communicate via telephone or regular mail to ensure security of the secret key 222. Preferably, the secret key 222 comprises a symmetric cryptographic key.

In certain embodiments, the FRAT 220, also referred to as a cross-realm authentication token, is identical to token definitions for inter-realm communication between homogeneous realms according to the second authentication protocol 218. Alternatively, the FRAT 220 is sufficiently similar to native FRATs that the FRAT is accepted by authentication modules of the foreign realm, Realm B 212. The FRAT 220 is compatible.

Operation of the apparatus 200 will now be described by way of example. Suppose the principal 204 desires a software service available from the service provider 206 in Realm B 212. Initially, the principal 204 requests authentication of its identity and/or that of its user with the authentication gateway 202. The authentication gateway 202 authenticates the principal 204 using the first authentication protocol 214. During the authentication, the principal 204 and authentication gateway 202 may exchange various types of authentication information including a SAML token that includes authentication information and/or access rights information. Next, if the principal 204 is authenticated, a generator 224 within the authentication gateway 202 generates a FRAT 220 compatible with the second authentication protocol 218.

The authentication gateway 202 sends the FRAT 220 to the principal 204. The FRAT 220 may include the address for the foreign realm authentication module 208. The principal 204 sends the FRAT 220 to the foreign realm authentication module 208. In response, after authenticating the FRAT 220, the foreign realm authentication module 208 sends an inter-realm token 226. The foreign realm authentication module 208 treats the FRAT 220 as though it originated from a foreign realm that also uses the second authentication protocol 218, even though this is not the case. The FRAT 220 comprises a request for a token to communicate with the service provider 206.

The inter-realm token 226 complies with the protocol and requirements of the second authentication protocol 218. For example, if the second authentication protocol 218 is Kerberos, the inter-realm token 226 may include the a symmetric key of the service provider 206 that is encrypted using a session key. The principal 204 then sends the inter-realm token 226 to the service provider 206 to request the desired service. The service provider 206 authenticates the inter-realm token 226 and then if properly authenticated provides the desired service to the principal 204. Of course once authenticated with the service provider 206, the principal 204 and service provider 206 may negotiate a session key for further communications.

The apparatus 200 utilizes the cross-realm features of the second authentication protocol 218. The second authentication protocol 218 remains unchanged. The principal 204 and authentication gateway 202 cooperate to allow authenticated communications between two heterogeneous authentication realms, Realm A 210 and Realm B 212.

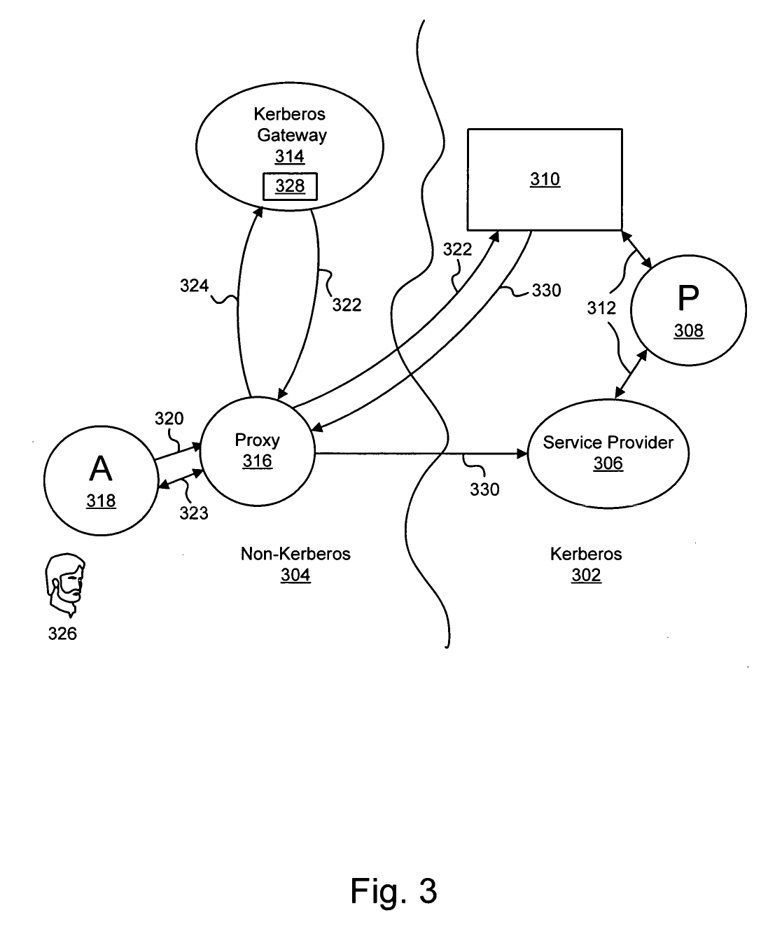

FIG. 3 illustrates an alternative embodiment of an apparatus for facilitating authenticated communication between authentication realms, namely an apparatus 300. The apparatus 300 includes a Kerberos realm 302 and a non-Kerberos realm 304. The Kerberos realm 302 includes one or more service providers 306, one or more principals 308, and a Kerberos authentication server 310 embodied as a KDC. As used herein, the term Kerberos authentication server 310 is intended to include an authentication server and a ticket granting service which may be combined or in separate modules. Members of the Kerberos realm 302 communicate using a standard Kerberos authentication protocol 312. The service providers 306, principals 308, and Kerberos authentication server 310 operate in substantially the same manner as described above in relation to FIG. 2 regarding the service provider 206, foreign realm authentication module 208, and principals 216.

The non-Kerberos realm 304 includes a Kerberos gateway 314 and a proxy 316. The Kerberos gateway 314 functions in substantially the same manner as the authentication gateway 202 described above in relation to FIG. 2. The proxy 316 performs the same functions as the principal 204 described in relation to FIG. 2.

Advantageously, the proxy 316 separates the logic required for authenticated inter-realm communication from the logic that implements a particular user software application 318 desiring a service from a foreign realm such as the Kerberos realm 302. Consequently, a plurality of user software applications 318 may employ the proxy 316 to obtain services in a foreign realm such as the Kerberos realm 302 without having to include the same logic in each user software application 318. Consolidating the logic in the proxy 316 facilitates maintenance and deployment of the software implementing the proxy 316.

The proxy 316 serves as an intermediary for user applications 318. The proxy 316 is configured to send a non-Kerberos authentication token 320 received from the user application 318 to the Kerberos gateway 314. The proxy 316 receives a cross-realm authentication token 322 which the proxy 316 sends to the service provider 306. Once authenticated with the service provider 306, the proxy 316 exchanges communications 323 between the user application 318 and the service provider 306. The proxy 316 may reside on a computing device separate from a computing device executing the user application 318. Alternatively, the proxy 316 may comprise a layer within an operating system, a dynamically loadable module such as a Dynamically Linked Library (DLL), an applet, or the like.

Preferably, the non-Kerberos authentication token 320 is compatible with a non-Kerberos authentication protocol 324. For example, the non-Kerberos authentication token 320 may include authentication credentials such as a user name and password and may be formatted as required by the non-Kerberos authentication protocol 324. In one embodiment, the non-Kerberos authentication token 320 comprises a SAML token.

Those of skill in the art will recognize that authentication processes may be unilateral or bilateral. Furthermore, authentication processes may include various authentication information including passwords, secret keys, challenge-response sessions and identify information such as user names, login IDs, and the like. As used herein, authentication is typically described for clarity as a unilateral process of the receiver authenticating the sender. However, the present invention is intended to cover both unilateral and bilateral authentication as well as various forms of authentication information. In addition, those of skill in the art will recognize that the tokens and/or tickets described include addressing information regarding the receiver and/or sender as well as encrypted and plain text indicators according to the protocol that requires the token and/or tickets.

Initially, a user 326 provides authentication credentials to the user application 318. The user application 318 generates a non-Kerberos authentication token 320 which is sent to the proxy 316. The proxy 316 authenticates the user 326 according to the non-Kerberos authentication protocol 324 by sending the non-Kerberos authentication token 320 to the Kerberos gateway 314. The Kerberos gateway 314 authenticates based on the non-Kerberos authentication token 320. If the token 320 is authentic, a generator 328 in the Kerberos gateway 314 generates a cross-realm authentication token 322 which is sent to the proxy 316. The proxy 316 sends the cross-realm authentication token 322 to the Kerberos authentication server 310 which authenticates the proxy 316. The Kerberos authentication server 310 then sends a cross-realm session token 330 to the proxy 316. Next, the proxy 316 sends the cross-realm session token 330 to the service provider 306. The service provider 306 authenticates the cross-realm session token 330 and, if authenticated, establishes communications with the proxy 316.

Advantageously, the user application 318 and proxy 316 may reside within a non-Kerberos realm 304 but still have access to services of a Kerberos realm 302 without any changes to the Kerberos protocol 312. In addition, the user applications 318 are not required to include special security or authentication modules. So long as the user application 318 can produce a non-Kerberos authentication token 320 compatible with the non-Kerberos authentication protocol 324, the application 318 may use the apparatus 300.

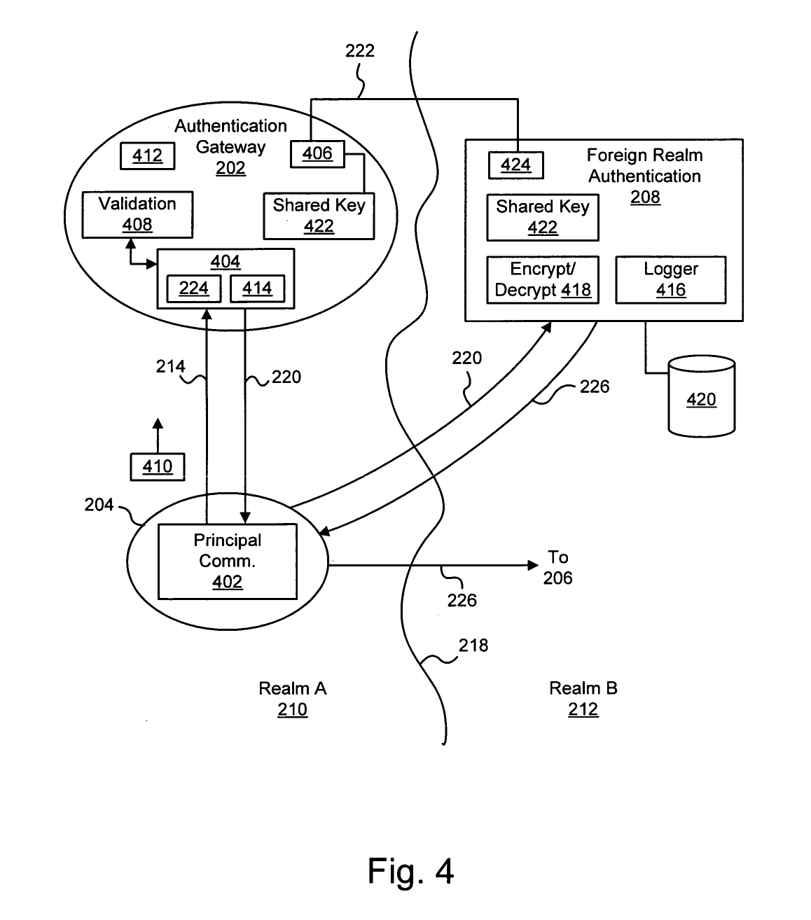

FIG. 4 illustrates more details of the apparatus 200 facilitating authenticated communication between authentication realms described in relation to FIG. 2. Specifically, the principal 204 may include a principal communication module 402 configured to manage authentication communications between the principal 204 and the authentication gateway 202, foreign realm authentication module 208, and the service provider 206. The principal communication module 402 may include logic configured to send the FRAT 220 to the foreign realm authentication module 208. The principal communication module 402 receives the inter-realm token 226 which may correspond to a session token 226. Typically, a session token 226 is proof of authentication that the principal 204 can use for a limited time, usually a few hours, to obtain services from the service provider 206. The principal communication module 402 sends the session token 226 to the service provider 206. After authenticating the session token 226, the service provider 206, in one embodiment, subsequently establishes service related communications through the principal communication module 402 with the principal 204.

The authentication gateway 202 includes a gateway communication module 404, a registration module 406, and a validation module 408. The gateway communication module 404 exchanges tokens and messages with the principal communication module 402. Typically, under a first authentication protocol 214, the principal 204 sends an authentication token 410 to the gateway communication module 404. The authentication token 410 may be incompatible with the second authentication protocol 214.

The gateway communication module 404 communicates the authentication token 410 to the validation module 408. In certain embodiments, the validation module 408 corresponds to one of a plurality of authentication protocols supported by the authentication gateway 202. The gateway communication module 404 may direct the authentication token 410 to the appropriate validation module 408 based on a type identifier within the token 410.

In accordance with certain authentication protocols, the authentication token 410 may include one or more encrypted messages. In one embodiment, the authentication token 410 is a non-Kerberos authentication token 410. To validate the authentication token 410, the validation module 408 may pass the encrypted messages and suitable keys to an encryption/decryption module 412 for decryption as needed. The encryption/decryption module 412 may include well known cryptography algorithms to encrypt and decrypt messages as needed.

If the validation module 408 determines that the authentication token 410 is valid and authentic, the validation module 408 provides an affirmative response to the gateway communication module 404. In response to the affirmative response, the generator 224 generates the FRAT 220. In certain embodiments, a packager 414 within the gateway communication module 404 may embed the authentication token 410 within the FRAT 220. In certain embodiments, the second authentication protocol 218, such as Kerberos, provides fields in the FRAT 220 for embedding the authentication token 410. The gateway communication module 404 then sends the FRAT 220 to the principal communication module 402.

Embedding the authentication token 410 in the FRAT 220 allows the foreign realm authentication module 208 to track and/or monitor access to services in Realm B 212 from Realm A 210. Preferably, the authentication token 410 includes sufficient information to identify the principal 204 and/or the user. Such tracking may be useful in determining security threats, identifying sources of security breaches, monitoring use of services from non-realm member principals, billing for fee based services, and the like.

The foreign realm authentication module 208 includes a logger 416 and an encryption/decryption module 418. The logger 416 may optionally log all received FRATs 220. Each FRAT 220 indicates an attempt to access Realm B 212. Alternatively, the logger 416 may create a log record when a FRAT 220 has been authenticated and an inter-realm token 226 is sent. Log records generated by the logger 416 may be stored in a database 420. Log records may include various information regarding the FRAT 220 and the inter-realm token 226 issued. For example, the log record may include the FRAT 220, an authentication token 410 extracted from the FRAT 220, a timestamp, and the like.

The encryption/decryption module 418 assists the foreign realm authentication module 208 to authenticate tokens generate response tokens by encrypting and decrypting one or more messages within the FRAT 220 and/or inter-realm token 226. Exactly which messages are encrypted/decrypted depends on the particular second authentication protocol 218 being used.

In one embodiment, in order for the foreign realm authentication module 208 to properly authenticate the FRAT 220, the foreign realm authentication module 208 and the authentication gateway 202 share a secret key 422. The authentication gateway 202 uses the secret key 422 to encrypt a message within the FRAT 220. The message may comprise for example a timestamp and an identifier that uniquely identifies the authentication gateway 202. The foreign realm authentication module 208 decrypts the message using the secret key 422. If the identifier matches a pre-registered identifier for the authentication gateway 202 and the timestamp satisfies certain time thresholds, the FRAT 220 and sender, authentication gateway 202, are authentic. Consequently, the foreign realm authentication module 208 issues an inter-realm token 226 permitting the principal 204 to access a desired service in the foreign realm, Realm B 212.

The registration module 406 registers the authentication gateway 202 with the foreign realm authentication module 208 by way of a corresponding registration module 424. In one embodiment, the registration module 424 obtains unique identifying information from registration module 406 regarding the authentication gateway 202. For example, the registration module 406 may send a unique identifier name, a unique Internet Protocol (IP) address, a serial number, a combination of these, or the like. Once an authentication gateway 202 is registered, the foreign realm authentication module 208 can authenticate that FRATs 220 received have in fact been issued by the authentication gateway 202. The authentication gateway 202 is then permitted to issue valid FRATs 220 using the secret key 422. The authentication gateway 202 determines based on the first authentication protocol 214 whether to issue a FRAT 220 to a particular principal 204.

Preferably, the secret key 422 is communicated to the authentication gateway 202 using non-electronic means. In one embodiment, a technician configuring the authentication gateway 202 inputs the secret key 422 received via a telephone conversation with a technician operating the foreign realm authentication module 208. The secret key 422 may be randomly generated by the foreign realm authentication module 208.

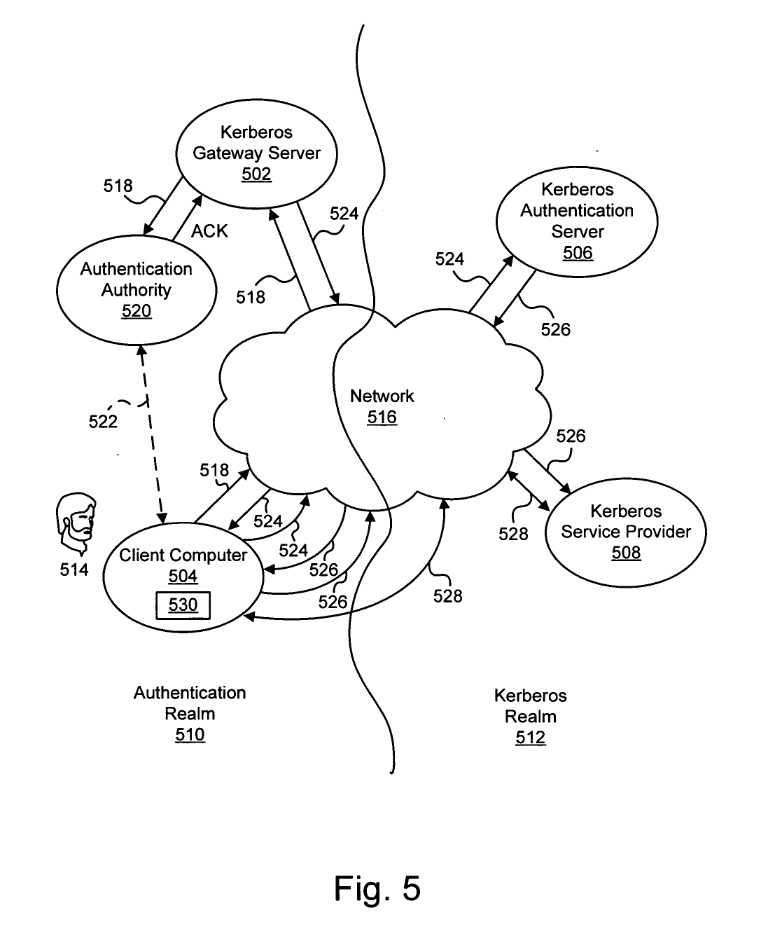

FIG. 5 illustrates a system 500 for facilitating authenticated communication between authentication realms. The system 500 includes modules and components that correspond to and perform substantially the same functions as modules and apparatuses discussed above in relation to FIGS. 2-5. Specifically, the system 500 includes a Kerberos gateway server 502, client computer 504, Kerberos authentication server 506, and Kerberos service provider 508.

The Kerberos gateway server 502 performs substantially the same functionality as the Kerberos gateway 314 described in relation to FIG. 3. The Kerberos gateway server 502 is registered with the Kerberos authentication server 506 as a gateway between an authentication realm 510 and a Kerberos realm 512. The Kerberos gateway server 502 in one aspect operates on a separate computing device in communication with the client 504 over a network 516. The Kerberos gateway server 502 authenticates a user 514 by receiving a non-Kerberos authentication token 518.

The non-Kerberos authentication token 518 may be substantially the same as the authentication token 410 discussed above. Preferably, the authentication token 410, 518 identifies a requested service available from a Kerberos service provider 508 in the Kerberos realm 512, and includes credentials for the client/user 514 such as user name and password. The authentication token 410, 518 may also include security role information such as an indicator as to the services the client 504 is permitted to access. In certain embodiments, the authentication token 518 is a SAML token 518 issued by an authentication authority 520. The authentication authority 520 may authenticate the client 504 using a non-Kerberos authentication protocol 522. The SAML token 518 asserts that the client 504 is authentic. The Kerberos gateway server 502 may verify the SAML token 518 with the authentication authority 520. The Kerberos gateway server 502 then issues Ticket-Granting-Ticket (TGT) 524 which is one example of a FRAT 220 or a cross-realm authentication token 322.

The client computer 504 subsequently sends the TGT 524 to the Kerberos authentication server 506 which authenticates the TGT 524 and responds with a cross-realm ticket 526. The cross-realm ticket 526 is one example of a session token 226 described in relation to FIG. 2. Typically, the cross-realm ticket 526 has a limited time period during which the ticket 526 can be used.

Next, the client 504 sends the cross-realm ticket 526 to the Kerberos service provider 508. The Kerberos service provider 508 verifies the cross-realm ticket 526 and in response to successful verification establishes a cross-realm communication session 528 with the client 504. With the cross-realm communication session 528 established, the user application 530 then uses the services of the Kerberos service provider 508 from within another authentication realm 510. The authentication realm may comprise a Kerberos realm or a non-Kerberos realm. In addition, the Kerberos authentication protocol is not changed to permit authenticated inter-realm communication.

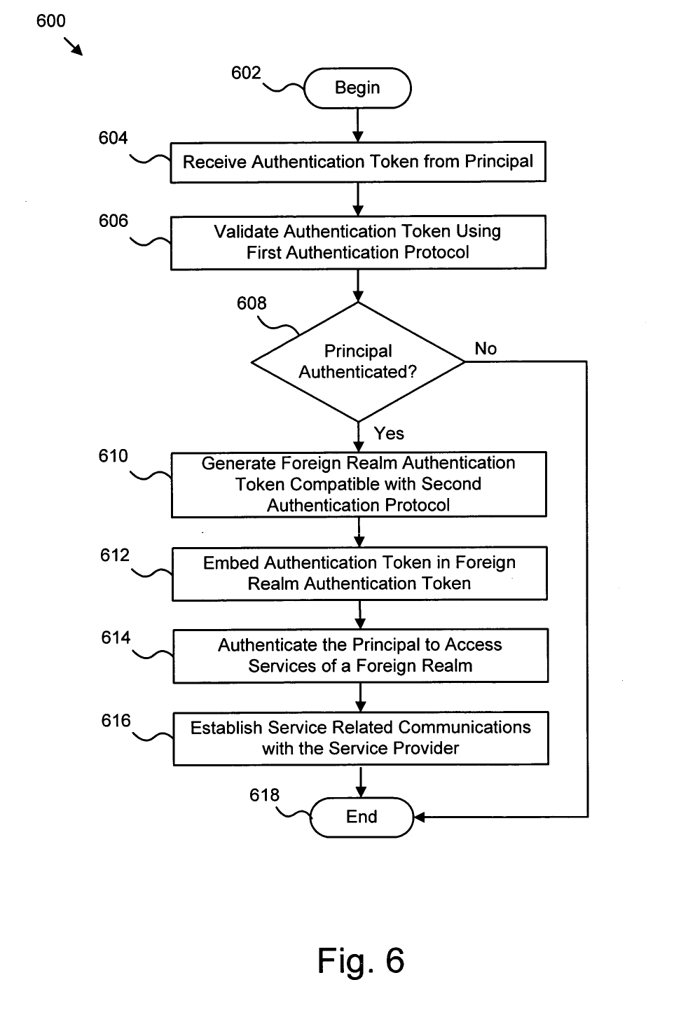

FIG. 6 illustrates a flow chart of a method 600 for facilitating authenticated communication between authentication realms according to one embodiment. The method 600 begins 602 when a principal 204 desires access to services provided by a service provider 206 in a foreign realm 212 that uses a different authentication protocol 218. To begin 602, the principal 204 prepares an authentication token 518 which is communicated to an authentication gateway 202. In one embodiment, the authentication gateway 202 is integrated with the principal 204. Alternatively, the authentication gateway 202 is separate from and in communication with the principal 204.

The authentication gateway 202 receives 604 the authentication token 518. Subsequently, the authentication gateway 202 communicates with a validation module 408 which validates 606 the authentication token 518. The manner in which the authentication token 518 is validated varies because validation is performed in accordance with the first authentication protocol 214. In certain embodiments, the authentication token 518 is a SAML token 518. Consequently, an assertion within the SAML token 518 may be sufficient to satisfy the first authentication protocol 214. Alternatively, the authentication gateway 202 communicates with an authentication authority 520. In addition, the authentication gateway 202 may have subsequent communications with the principal 204 to validate 606 the authentication token 518.

Next, a determination 608 is made whether the principal 204 is authenticated, based at least in part on the validation of the authentication token 518. If the principal 204 is not authenticated, the method 600 ends.

If the principal 204 is authenticated, the generator 224 generates 610 a Foreign Realm Authentication Token (FRAT) 220. In certain embodiments, the FRAT 220 comprises a cross-realm authentication token, a TGT 524, or a cross-realm TGT. Preferably, the FRAT 220 is configured for inter-realm communication and is compatible with a second authentication protocol 218. The second authentication protocol 218 is the authentication protocol for the foreign realm 212.

In certain embodiments, the packager 414 within the gateway communication module 404 embeds 612 the authentication token 410 within the FRAT 220. Next, the principal 204 communicates the FRAT 220 to the foreign realm authentication module 208.

The foreign realm authentication module 208 authenticates 614 the principal 204 to access services from service provider 206 in the foreign realm 212. Typically, this may include sending a cross-realm ticket or token 526 to the principal 204 once the principal 204 is successfully authenticated.

Finally, the principal 204 provides the cross-realm ticket 526 to the service provider 206. The service provider 206 authenticates the principal 204 using the cross-realm ticket 526. Then, the service provider 206 and principal 204 cooperate to establish 616 authenticated service related communications with each other. In certain embodiments, this may comprise negotiating a session key used to encrypt and decrypt subsequent communications between the service provider 206 and the principal 204. Then, the method 600 ends 618.

Those of skill in the art will appreciate the benefits and advantages provided by the apparatus, system, and method for facilitating authenticated communications between authentication realms described herein. Beneficially, the present invention does not require any changes to existing authentication systems, in particular foreign authentication systems, such as Kerberos. In addition, the present invention allows clients to communicate directly with an authentication authority such as a KDC such that activity of the clients can be properly tracked and recorded. The present invention also can support various non-Kerberos authentication systems without requiring any modifications to existing Kerberos authentication systems.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagram(s) herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for facilitating authenticated communication between authentication realms, the apparatus comprising:
an authentication gateway configured to authenticate a principal using a first authentication protocol;
a generator configured to generate a foreign realm authentication token compatible with a second authentication protocol and configured for inter-realm communication; and
a foreign realm authentication module configured to authenticate the principal to access services of a foreign realm using the foreign realm authentication token in accordance with the second authentication protocol.

2. The apparatus of claim 1, wherein the foreign realm authentication token is compatible with a token definition in the second authentication protocol for foreign realm authentication tokens.

3. The apparatus of claim 1, wherein the first authentication protocol is different from the second authentication protocol that includes a token definition for foreign realm authentication tokens.

4. The apparatus of claim 1, further comprising a registration module configured to register the authentication gateway with the foreign realm authentication module such that the authentication gateway has authority to issue foreign realm authentication tokens to principals satisfying authentication requirements of the authentication gateway.

5. The apparatus of claim 1, further comprises a gateway communication module configured to receive an authentication token from the principal, the authentication token incompatible with the second authentication protocol, and a validation module configured to validate the authentication token according to the first authentication protocol.

6. The apparatus of claim 5, wherein the authentication token identifies a requested service within the foreign realm and includes credentials for the principal, the credentials comprising a user name and password.

7. The apparatus of claim 5, wherein the authentication token comprises a Security Assertions Markup Language (SAML) token generated by an authentication authority.

8. The apparatus of claim 1, wherein the authentication gateway shares a secret key with the foreign realm authentication module, the authentication gateway using the secret key to encrypt a message within the foreign realm authentication token, the foreign realm authentication module issuing an inter-realm token in response to successful decryption of the message using the secret key, the inter-realm token permitting authenticated access by the principal to a service of the foreign realm.

9. The apparatus of claim 1, further comprising a packager configured to embed an authentication token from the principal in the foreign realm authentication token, the authentication token identifying the principal, and a logger configured to log access to the foreign realm by the principal by way of the foreign realm authentication module.

10. The apparatus of claim 1, further comprising a principal communication module configured to,
send the foreign realm authentication token to the foreign realm authentication module;
receive a session token valid for services of service providers in the foreign realm according to the second authentication protocol;
send the session token to a service provider; and
establish service related communications with the service provider in response to the service provider validating the session token.

11. An apparatus for facilitating authenticated communication between authentication realms, the apparatus comprising:
a generator configured to generate a cross-realm authentication token compatible with a Kerberos authentication protocol;
a proxy configured to send a non-Kerberos authentication token from a user application, receive the cross-realm authentication token, and exchange communications between the user application and a service in a Kerberos realm in response to successful inter-realm authentication;
a Kerberos gateway configured to receive the non-Kerberos authentication token from the proxy and authenticate the user application using a non-Kerberos authentication protocol; and
a Kerberos authentication server configured to authenticate the proxy to access services of the Kerberos realm using the cross-realm authentication token and in accordance with the Kerberos authentication protocol.

12. The apparatus of claim 11, wherein the cross-realm authentication token comprises a valid Ticket-Granting-Ticket (TGT) for the Kerberos realm.

13. The apparatus of claim 11, further comprising a gateway communication module configured to receive the non-Kerberos authentication token from the proxy, the non-Kerberos authentication token incompatible with the Kerberos authentication protocol, and a validation module configured to validate the non-Kerberos authentication token according to the non-Kerberos authentication protocol.

14. The apparatus of claim 11, further comprising a packager configured to embed the non-Kerberos authentication token from the user application in the cross-realm authentication token, the non-Kerberos authentication token identifying the user application, and a logger configured to log access to the Kerberos realm by the user application by way of the Kerberos authentication server.

15. A system for facilitating authenticated communication between authentication realms, the system comprising:
a client computer within an authentication realm, the client computer configured to solicit credentials from a user of an application and generate a non-Kerberos authentication token;
a Kerberos gateway server registered as a gateway between the authentication realm and a foreign authentication realm, the Kerberos gateway server configured to receive and authenticate the non-Kerberos authentication token and to issue a Ticket-Granting-N Ticket (TGT) to the client computer in response to authentication of the user using a non-Kerberos authentication protocol;
a Kerberos authentication server configured to issue a cross-realm ticket and to send the cross-realm ticket to the client computer in response to the TGT from the client computer;
a Kerberos service provider configured to establish a cross-realm communication session with the user application on the client computer in response to the cross-realm ticket from the client computer; and
a network configured to operatively couple the client computer, Kerberos gateway server, Kerberos authentication server, and Kerberos service provider for networked communications.

16. The system of claim 15, further comprising a packager configured to embed the non-Kerberos authentication token from the user application in the TGT, the non-Kerberos authentication token identifying the user application, and a logger configured to log access to the Kerberos realm by the user application by way of the Kerberos authentication server.

17. The system of claim 15, further comprising a registration module configured to share a secret key between the Kerberos gateway and the Kerberos authentication server such that the Kerberos gateway uses the secret key to issue TGTs to the user application in response to the user application satisfying non-Kerberos authentication requirements of the Kerberos gateway.

18. A signal bearing medium tangibly embodying a program of machine-readable instructions executable by a digital processing apparatus to perform operations to facilitate authenticated communication between authentication realms, the operations comprising:
an operation to authenticate a principal using a first authentication protocol;
an operation to generate a foreign realm authentication token compatible with a second authentication protocol, the foreign realm authentication token configured for inter-realm communication; and
an operation to authenticate the principal to access services of a foreign realm using the foreign realm authentication token and in accordance with the second authentication protocol.

19. The signal bearing medium of claim 18, wherein the foreign realm authentication token is compatible with a token definition in the second authentication protocol for foreign realm authentication tokens.

20. The signal bearing medium of claim 18, wherein the first authentication protocol is different from the second authentication protocol that includes a token definition for foreign realm authentication tokens.

21. The signal bearing medium of claim 18, further comprising an operation to register an authentication gateway with a foreign realm authentication server such that the authentication gateway has authority to issue foreign realm authentication tokens to principals satisfying authentication requirements of the authentication gateway.

22. The signal bearing medium of claim 18, wherein the operation to authenticate a principal using a first authentication protocol further comprises an operation to receive an authentication token from the principal, the authentication token incompatible with the second authentication protocol, and an operation to validate the authentication token according to the first authentication protocol at an authentication authority.

23. The signal bearing medium of claim 22, wherein the authentication token identifies a requested service within the foreign realm and includes credentials for the principal, the credentials comprising security role information.

24. The signal bearing medium of claim 18, wherein the operation to generate a foreign realm authentication token further comprises an operation to encrypt a message within the foreign realm authentication token using a secret key shared with a foreign realm authentication server, the foreign realm authentication server configured to issue an inter-realm token that permits the principal authenticated access to a service of the foreign realm.

25. The signal bearing medium of claim 18, wherein the operation to generate a foreign realm authentication token further comprises an operation to embed an authentication token from the principal in the foreign realm authentication token, the authentication token identifying the principal, the operations further comprising an operation to log access to the foreign realm by the principal at a foreign realm authentication server.

26. The signal bearing medium of claim 18, wherein the operation to authenticate the principal to access services of a foreign realm further comprises, an operation to send the foreign realm authentication token to an authentication server configured to authenticate within the foreign realm;
an operation to receive a session token valid for services of service providers in the foreign realm according to the second authentication protocol;
an operation to send the session token to a service provider; and
an operation to establish service related communications with the service provider in response to the service provider validating the session token.

27. A method for facilitating authenticated communication between authentication realms, the method comprising:
authenticating a principal using a first authentication protocol;
generating a foreign realm authentication token compatible with a second authentication protocol, the foreign realm authentication token configured for inter-realm communication; and
authenticating the principal to access services of a foreign realm using the foreign realm authentication token and in accordance with the second authentication protocol.

28. The method of claim 27, further comprising registering an authentication gateway with a foreign realm authentication server such that the authentication gateway has authority to issue foreign realm authentication tokens to principals satisfying authentication requirements of the authentication gateway.

29. The method of claim 27, wherein generating a foreign realm authentication token further comprises embedding an authentication token from the principal in the foreign realm authentication token, the authentication token identifying the principal, the method further comprising logging access to the foreign realm by the principal at a foreign realm authentication server.

30. An apparatus for facilitating authenticated communication between authentication realms, the apparatus comprising:
means for authenticating a principal using a first authentication protocol;
means for generating a foreign realm authentication token compatible with a second authentication protocol, the foreign realm authentication token configured for inter-realm communication; and
means for authenticating the principal to access services of a foreign realm using the foreign realm authentication token and in accordance with the second authentication protocol.
